(19) United States
(12) Patent Application Publication
(10) Pub. No.: US 2015/0111124 A1
(43) Pub. Date: Apr. 23, 2015

(54) CATALYST SLURRY FOR FUEL CELL, AND ELECTRODE, MEMBRANE ELECTRODE ASSEMBLY AND FUEL CELL USING THE SAME

(71) Applicants: Korea Advanced Institute Of Science and Technology, Daejeon (KR); Samsung Electronics Co., Ltd., Suwon-si (KR)

(72) Inventors: Suk-Gi HONG, Seongnam-si (KR); Jung-ock PARK, Yongin-si (KR); Joon-hee KIM, Seoul (KR); Jung-ki PARK, Daejeon (KR); Keun-hwan OH, Daejeon (KR); Yoon-hoi LEE, Hwaseong-si (KR); Min-ju CHOO, Daejeon (KR); Jin-su HA, Cheonan-si (KR)

(73) Assignees: Korea Advanced Institute Of Science and Technology, Daejeon (KR); Samsung Electronics Co., Ltd., Suwon-si (KR)

(21) Appl. No.: 14/164,474

(22) Filed: Jan. 27, 2014

(30) Foreign Application Priority Data
Oct. 23, 2013 (KR) 10-2013-0126725

(51) Int. Cl. H01M 4/86

(52) U.S. Cl. CPC H01M 4/8663; H01M 2008/1095
USPC 429/457; 429/530; 429/480

(57) ABSTRACT

A catalyst slurry including a catalyst material, a polymer binder, a plurality of inorganic particles, wherein each particle includes an ionic group, a hydrophilic oligomer, and a solvent.

### CROSS-REFERENCE TO RELATED APPLICATIONS

This application claims priority to Korean Patent Application No. 10-2013-0126725, filed on Oct. 23, 2013, and all the benefits accruing therefrom under 35 U.S.C. §119, the content of which is incorporated herein by reference.

### BACKGROUND

1. Field

The present disclosure relates to catalyst slurries for fuel cells, and electrodes, membrane electrode assemblies, and fuel cells using the same.

2. Description of the Related Art

Fuel cells are power generation devices directly converting chemical energy of hydrogen from a hydrocarbon fuel such as natural gas, methanol, and ethanol, and oxygen from air into electrical energy. Fuel cells have high efficiency and high energy density. Fuel cells are clean energy sources and are alternatives to fossil energy sources. Fuel cells have various driving temperatures according to selected electrolyte. Fuel cells may output power in a variety of ranges by using a stack structure of unit cells. Thus, fuel cells have drawn attention as an energy source due to a wide range of applications from a compact and portable power source to a large-scale power generation.

Representative fuel cells may be classified into polymer electrolyte membrane fuel cells (“PEMFCs”) and direct methanol fuel cells (“DMFCs”). The fuel cells utilize a polymer membrane having proton conductivity.

Such fuel cell systems have a stack structure in which several to hundreds of membrane electrode assemblies (“MEAs”) are connected to each other in series via bipolar plates. A membrane electrode assembly, as core technology in fuel cells, has a structure in which an anode, which is a fuel electrode or an oxidation electrode, and a cathode, which is an air electrode or a reduction electrode, are disposed on both surfaces of a polymer electrolyte membrane including a proton conductive polymer.

The principle of generating electricity in a fuel cell is as follows. A fuel is supplied to an anode, which is a fuel electrode, adsorbed on a catalyst of the anode, and subsequently oxidized to produce hydrogen ions (protons) and electrons. The electrons are delivered to the cathode, which is a reduction electrode, via an external circuit, and the protons pass through a polymer electrolyte membrane to be delivered to the cathode. Oxygen is supplied to the cathode. The oxygen, protons, and electrons are combined on a catalyst of the cathode to generate electricity while generating water.

There remains a need to develop an electrode in which a fuel and oxygen are uniformly delivered, and protons efficiently migrate.

### SUMMARY

Provided are catalyst slurries for fuel cells to form a catalyst layer having high water retention properties.

Provided are electrodes and membrane electrode assemblies for fuel cells having excellent performance under low relative humidity environment by improving water retention properties of a catalyst layer.

Provided are fuel cells having excellent performance using the membrane electrode assemblies for fuel cells.

Additional aspects will be set forth in part in the description which follows and, in part, will be apparent from the description, or may be learned by practice of the presented embodiments.

According to another aspect, a catalyst slurry for a fuel cell includes
a catalyst material,
a polymer binder,
a plurality of inorganic particles, wherein each particle includes an ionic group,
a hydrophilic oligomer, and
a solvent.

The inorganic particles may have a water retention property.

The inorganic particles may include silica particles, zirconia particles, titania particles, alumina particles, zeolite particles, or a combination thereof.

The inorganic particles may have a diameter of about 1 nanometer to about 100 nanometers.

The ionic group may include a sulfo group, a carboxyl group, a phosphate group, a phosphono group, an imidazolyl group, a benzimidazolyl group, or a derivative any one or more of the foregoing groups.

The plurality of inorganic particles each including an ionic group may be a plurality of silica particles, wherein each silica particle includes a sulfo group.

A content of the inorganic particles each including an ionic group may be in the range of about 1% by weight to about 50% by weight based on the weight of the polymer binder.

The hydrophilic oligomer may include polyethylene glycol, polyvinyl alcohol, polyvinylpyrrolidone, or a combination thereof.

A content of the hydrophilic oligomer is in the range of about 1% by weight to about 50% by weight based on the weight of the polymer binder.

The catalyst material may include a support and a catalyst metal disposed on the support.

The support may include carbon powder, carbon black, acetylene black, ketjen black, activated carbon, carbon nanotube, carbon nanofiber, carbon nanowire, carbon nanohorn, carbon aerogel, carbon xerogel, carbon nanoring, or a combination thereof.

The catalyst metal may include platinum, palladium, ruthenium, iridium, osmium, a Pt—Pd alloy, a Pt—Ru alloy, a Pt—Ir alloy, a Pt—Os alloy, a Pt-M alloy, wherein M includes at least one element selected from titanium, vanadium, chromium, molybdenum, tungsten, manganese, iron, cobalt, rhodium, nickel, copper, silver, gold, zinc, gallium, and tin, or a combination thereof.

A content of the catalyst material may be in the range of about 10% by weight to about 1,000% by weight based on the weight of the polymer binder.

The polymer binder may include a fluorinate polymer, a benzimidazole polymer, a polyimide polymer, a polyetherimide polymer, a polyphenylenesulfide polymer, a polysulfone polymer, a polyethersulfone polymer, a polyetherketone polymer, a polyether-etherketone polymer, a polyphenylquinoxaline polymer, or a copolymer comprising any one or more of the foregoing polymers.

The polymer binder may include poly(perfluorosulfonic acid), poly(perfluorocarboxylic acid), a copolymer of tetrafluoroethylene and fluorovinylether including a sulfonic acid group, defluorinated polyetherketone sulfide, aryl ketone, poly(2,2′-(m-phenylene)-5,5′-bibenzimidazole), poly(2,5-benzimidazole), or a copolymer comprising any one or more of the foregoing polymers.

According to another aspect, an electrode for a fuel cell includes a gas diffusion layer, and a catalyst layer disposed on the gas diffusion layer, wherein the catalyst layer includes the catalyst slurry.

According to another aspect, a membrane electrode assembly includes a cathode, an anode disposed to face the cathode, and an electrolyte membrane disposed between the cathode and the anode, wherein at least one of the cathode and the anode includes the electrode.

The electrolyte membrane may include at least one polymer electrolyte membrane selected from poly(perfluorosulfonic acid), poly(perfluorocarboxylic acid), a copolymer of tetrafluoroethylene and fluorovinylether including a sulfonic acid group, defluorinated polyetherketone sulfide, aryl ketone, poly(2,2′-(m-phenylene)-5,5′-bibenzimidazole), poly(2,5-benzimidazole), and a copolymer comprising any one or more of the foregoing polymers.

According to another aspect, a fuel cell includes a plurality of the membrane electrode assemblies connected to each other via a plurality of bipolar plates.

### BRIEF DESCRIPTION OF THE DRAWINGS

These and/or other aspects will become apparent and more readily appreciated from the following description of the embodiments, taken in conjunction with the accompanying drawings in which:

FIG. 1 is an exploded perspective view of a fuel cell according to an embodiment;

FIG. 2 is a cross-sectional view of a membrane electrode assembly (“MEA”) constituting the fuel cell of FIG. 1;

FIG. 3 is a graph of absorbance (arbitrary units, a. u.) versus wave number (reverse centimeters, cm⁻¹) illustrating infrared (“IR”) spectrum results of commercially available silica particles and silica particles having sulfo groups of Example 1-(a);

FIG. 4 is a graph of cell potential (volts, V) and power density (watts per square centimeter, W/cm²) versus current density (amperes per square centimeter, A/cm²) illustrating cell potentials and power densities of unit cells prepared according to Example 1 and Comparative Examples 1 and 2 with respect to current density; and

FIG. 5 is a graph of imaginary part of impedance (Ohm·square centimeters, Ohm·cm²) versus real part of impedance (Ohm·square centimeters, Ohm·cm²) illustrating alternating current (“AC”) impedance of unit cells prepared according to Example 1 and Comparative Examples 1 and 2.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

It will be understood that when an element is referred to as being “on” another element, it can be directly in contact with the other element or intervening elements may be present therebetween. In contrast, when an element is referred to as being “directly on” another element, there are no intervening elements present.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The term “low relative humidity” as used herein refers to a relative humidity greater than 0% and equal or less than about 80%.

The term “ionic group” as used herein refers to a functional group capable of forming an ionic bond such as a sulfo group and a carboxyl group.

The term “water retention properties” as used herein refers to properties capable of retaining moisture due to high affinity to the moisture.

Hereinafter, a catalyst slurry for fuel cells according to an embodiment will be described in detail. The catalyst slurry for fuel cells includes
a catalyst material,
a polymer binder,
a plurality of inorganic particles, wherein each particle includes an ionic group,
a hydrophilic oligomer, and
a solvent.

The catalyst material may include a support and a catalyst metal supported thereby. The support may be a carbonaceous support such as carbon powder, carbon black, acetylene black, ketjen black, activated carbon, carbon nanotube, carbon nanofiber, carbon nanowire, carbon nanohorn, carbon aerogel, carbon xerogel, or carbon nanoring, or any combination thereof. An average particle diameter of the carbonaceous support may be in the range of about 20 nanometers (“nm”) to about 50 nm.

The catalyst metal may include platinum (Pt), palladium (Pd), ruthenium (Ru), iridium (Ir), osmium (Os), a Pt—Pd alloy, a Pt—Ru alloy, a Pt—Ir alloy, a Pt—Os alloy, a Pt-M alloy, wherein M includes at least one element selected from titanium (Ti), vanadium (V), chromium (Cr), molybdenum (Mo), tungsten (W), manganese (Mn), iron (Fe), cobalt (Co), rhodium (Rh), nickel (Ni), copper (Cu), silver (Ag), gold (Au), zinc (Zn), gallium (Ga), and tin (Sn), and any combination thereof. The catalyst metal may be a nanoparticle having an average particle diameter of 10 nm or less. When the average particle diameter is greater than 10 nm, the activity of the catalyst metal may decrease due to a small surface area. For example, the average particle diameter of the catalyst metal may be in the range of about 2 nm to about 10 nm.

For example, the catalyst material may be a Pt-based catalyst supported by a carbonaceous support. The catalyst material may be an alloy of Pt and Co supported by carbon powder such as a PtCo/C alloy.

The content of the catalyst material may be in the range of about 1% by weight to about 10% by weight based on the total weight of the catalyst slurry for fuel cells. Meanwhile, the content of the catalyst metal may be in the range of about 10% by weight to about 1,000% by weight based on the weight of the support. When the content of the catalyst metal is within the range described above, availability of the catalyst metal may be increased and performance of a fuel cell may be maintained at a high level.

The polymer binder may be a polymer having proton conductivity (proton conductive polymer). For example, the proton conductive polymer may have, at a side chain thereof, at least one positive ion exchange group selected from a sulfo group (—SO₃H), a carboxyl group (—COOH), a phosphate group (—OP(═O)(OH)₂), a phosphono group (—P(═O)(OH)₂), and a derivative thereof. The proton conductive polymer may include at least one polymer selected from a fluorinate polymer, a benzimidazole polymer, a polyimide polymer, a polyetherimide polymer, a polyphenylenesulfide polymer, a polysulfone polymer, a polyethersulfone polymer, a polyetherketone polymer, a polyether-etherketone polymer, a polyphenylquinoxaline polymer, and copolymers thereof.

For example, the polymer binder may include poly(perfluorosulfonic acid) (“NAFION™”), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), poly(2,5-benzimidazole), or any copolymer thereof.

The content of the polymer binder may be in the range of about 1% by weight to about 20% by weight based on the total weight of the catalyst slurry for fuel cells.

The inorganic particles be hydrophilic, i.e., having a water retention property. The inorganic particles with water retention properties may be silica, zirconia, titania, alumina, or zeolite. However, any inorganic particles having excellent water retention properties may also be used without limitation. Due to high hydrophilicity, the inorganic particles with water retention properties may facilitate migration of protons in a catalyst layer under low relative humidity environment.

The inorganic particles with water retention properties may respectively have an ionic group on the surface thereof. The ionic group may include a sulfo group (—SO₃H), a carboxyl group (—COOH), a phosphate group (—OP(═O)(OH)₂), a phosphono group (—P(═O)(OH)₂), an imidazole group, a benzimidazole group, or a combination thereof. The ionic group may further improve migration of protons in the catalyst layer via ion exchange.

The inorganic particles each including an ionic group may be silica particles, wherein each silica particle includes a sulfo group.

The ionic group-containing inorganic particles with a water retention property may have a particle diameter of about 0.01 micrometers (“μm”) to about 1 μm. The content of the ionic group-containing inorganic particles with water retention properties may be in the range of about 1% by weight to about 50% by weight, for example, about 1% by weight to about 30% by weight, for example, about 1% by weight to about 10% by weight, based on the weight of the polymer binder. When the particle diameter and the content of the inorganic particles with water retention properties are within the ranges described above, water retention properties may be efficient in the catalyst layer.

The hydrophilic oligomer may stabilize dispersion of the inorganic particles with water retention properties in the catalyst slurry. In addition, the hydrophilic oligomer may be dissolved in water generated during operation of the fuel cell to form pores in the catalyst layer. Examples of the hydrophilic oligomer may include polyethylene glycol (“PEG”), polyvinyl alcohol (“PVA”), and polyvinylpyrrolidone (“PVP”). The content of the hydrophilic oligomer may be in the range of about 1% by weight to about 50% by weight, for example, about 5% by weight to about 45% by weight, for example, about 10% by weight to about 40% by weight, based on the weight of the polymer binder. When the content of the hydrophilic oligomer is within the range described above, the catalyst layer may have a porous structure suitable for gas diffusion and proton transport.

Examples of the solvent may include water, ethyl alcohol, isopropyl alcohol, butyl alcohol, ethylene glycol, propylene glycol, methyl pyrrolidone, tetrahydrofuran, acetone, or any mixture thereof, without being limited thereto. For example, a mixture of water and isopropyl alcohol may be used as the solvent. The solvent may be used in an amount suitable for forming a slurry having an appropriate viscosity, and constitute the remaining content of the slurry.

Hereinafter, a method of preparing an electrode catalyst layer for fuel cells according to an embodiment will be described in detail.

A polymer binder solution is prepared by dispersing the inorganic particles having ionic groups in the proton conductive polymer binder (“S10”). To this end, inorganic particles having surfaces to which ionic groups are affixed are prepared. Any method may be used to prepare the inorganic particles without limitation. The inorganic particles may be synthesized from precursors using a known method, or any commercially available inorganic particles may be used.

Any inorganic particles with high water retention properties may be used, and for example, silica, zirconia, titania, alumina, zeolite, or a combination thereof may be used. The inorganic particles may have a particle diameter of about 1 nm to about 100 nm.

The ionic group may be any ionic group that is known to have proton conductivity or facilitate conducting of protons in a fuel cell. Examples of the ionic group may include a sulfo group (—SO₃H), a carboxyl group (—COOH), a phosphate group (—OP(═O)(OH)₂), a phosphono group (—P(═O)(OH)₂), an imidazole group, a benzimidazole group, and a derivative thereof.

In order to form the ionic group on the surface of each of the inorganic particles, a hydrophilic group such as a hydroxyl group is formed on the surface of the inorganic particle, and the inorganic particles having the hydrophilic groups are mixed with sulfonic acid, carboxylic acid, phosphoric acid, phosphonic acid, imidazole, benzimidazole, or a derivative thereof, such that the hydrophilic groups are substituted with the ionic groups such as sulfo groups, carboxyl groups, phosphate groups, phosphono groups, imidazole groups, benzimidazole groups, or a derivative thereof. Then, the inorganic particles are washed to remove materials not involved in the reaction and dried.

The inorganic particles having the ionic groups on the surfaces thereof prepared as described above are dispersed in a proton conductive polymer binder solution. In this regard, the inorganic particles having the ionic groups may be dispersed in the proton conductive polymer binder solution such that the content of the inorganic particles is in the range of about 0.01% by weight to about 10% by weight based on the weight of the proton conductive polymer binder solution.

The proton conductive polymer binder solution may be prepared by dissolving the proton conductive polymer in a first solvent, or any commercially available proton conductive polymer binder solution may be used.

Examples of the proton conductive polymer may include at least one polymer selected from a fluorinate polymer, a benzimidazole polymer, a polyimide polymer, a polyetherimide polymer, a polyphenylenesulfide polymer, a polysulfone polymer, a polyethersulfone polymer, a polyetherketone polymer, a polyether-etherketone polymer, a polyphenylquinoxaline polymer, and copolymers comprising any one or more of the foregoing polymers. Particularly, the proton conductive polymer resin may include poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), poly(2,5-benzimidazole, any combination thereof, or any copolymer comprising any one or more of the foregoing polymers.

The first solvent, for example, may be water, ethyl alcohol, isopropyl alcohol, methyl pyrrolidone, or any mixture thereof.

The content of the proton conductive polymer may be in the range of about 10% by weight to about 50% by weight based on the weight of the first solvent.

Meanwhile, a hydrophilic oligomer solution is prepared by dissolving the hydrophilic oligomer in a second solvent (“S20”). Examples of the hydrophilic oligomer may include polyethylene glycol (“PEG”), polyvinyl alcohol (“PVA”), and polyvinylpyrrolidone (“PVP”). The hydrophilic oligomer may stabilize dispersion of the inorganic particle in the catalyst slurry. In addition, the hydrophilic oligomer may be dissolved in water generated during operation of the fuel cell to form pores in the catalyst layer.

Examples of the second solvent may include water, ethyl alcohol, isopropyl alcohol, butyl alcohol, ethylene glycol, propylene glycol, methyl pyrrolidone, tetrahydrofuran, acetone, or any mixture thereof. The content of the hydrophilic oligomer may be in the range of about 1% by weight to about 20% by weight based on the weight of the second solvent.

The binder solution prepared by dispersing the ionic group-containing inorganic particles in a mixture of the proton conductive polymer binder, the hydrophilic oligomer solution, and the catalyst material to prepare a catalyst slurry (“S30”).

The catalyst material may include a support and a catalyst metal supported by the support.

The support may be a carbonaceous support such as carbon powder, carbon black, acetylene black, ketjen black, activated carbon, carbon nanotube, carbon nanofiber, carbon nanowire, carbon nanohorn, carbon aerogel, carbon xerogel, and carbon nanoring, or any combination thereof. An average particle diameter of the carbonaceous support may be in the range of about 20 nm to about 50 nm.

The catalyst metal may include at least one selected from platinum (Pt), palladium (Pd), ruthenium (Ru), iridium (Ir), osmium (Os), a Pt—Pd alloy, a Pt—Ru alloy, a Pt—Ir alloy, a Pt—Os alloy, a Pt-M alloy, wherein M includes at least one element selected from titanium (Ti), vanadium (V), chromium (Cr), molybdenum (Mo), tungsten (W), manganese (Mn), iron (Fe), cobalt (Co), rhodium (Rh), nickel (Ni), copper (Cu), silver (Ag), gold (Au), zinc (Zn), gallium (Ga), and tin (Sn), and any combination thereof without being limited thereto. The catalyst metal may be a nanoparticle having an average particle diameter of about 2 nm to 10 nm.

The content of the catalyst material may be in the range of about 1% by weight to about 10% by weight based on the total weight of the catalyst slurry for fuel cells. Meanwhile, the content of the catalyst metal may be in the range of about 10% by weight to about 1,000% by weight based on the weight of the support.

A Pt-based catalyst supported by a carbonaceous support which is purchased or synthesized according to a process of supporting a Pt-based catalyst on a carbonaceous support may be used. The catalyst supporting process is well known in the art, and thus a detailed description thereof will not be given herein. For example, the catalyst material may be a Pt-based catalyst supported by a carbonaceous support. The catalyst material may be an alloy of Pt and Co supported by carbon powder such as a PtCo/C alloy.

The catalyst slurry is coated on a base to a uniform thickness and dried to form a catalyst layer (“S40”).

The coating process of the catalyst slurry may be performed by screen printing, spray coating, coating using a doctor blade, gravure coating, dip coating, silk screening, painting, or slot dye coating according to viscosity of a composition, without being limited thereto.

The electrode catalyst layer for a fuel cell prepared as described above includes the catalyst material, the proton conductive polymer binder, in which the ionic group-containing inorganic particles with water retention properties are dispersed, and the hydrophilic oligomer. The catalyst material catalyzes oxidation of hydrogen to generate protons and reduction of oxygen to generate water. The ionic group-containing inorganic particles with water retention properties may increase proton conductivity even under low relative humidity environment, and the hydrophilic oligomer may increase dispersibility of the inorganic particles and forms pores in the catalyst layer to facilitate the gas flow, thereby improving effect of the catalyst. The catalyst layer may have pores each having a diameter of about 20 nm to about 100 nm and a volume of about 0.03 milliliters per gram (“mL/g”) to about 0.06 mL/g.

The electrode catalyst layer for fuel cells may be used in both a cathode and an anode.

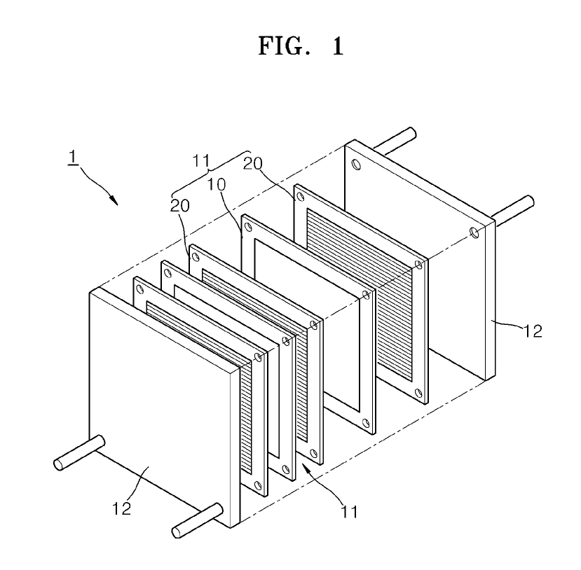

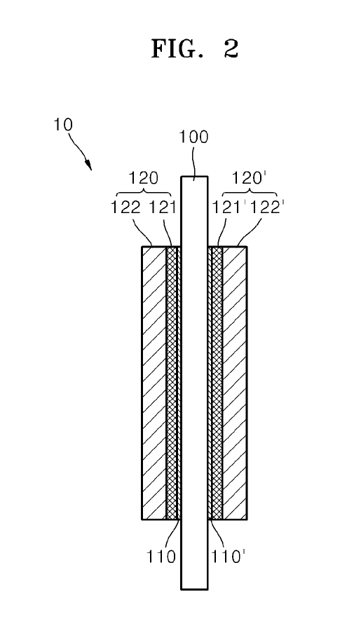

Hereinafter, a fuel cell and a membrane electrode assembly (“MEA”) according to embodiments will be described in detail. FIG. 1 is an exploded perspective view of a fuel cell 1 according to an embodiment. FIG. 2 is a cross-sectional view of a membrane electrode assembly (“MEA”) 10 constituting the fuel cell 1 of FIG. 1.

Referring to FIG. 1, in the fuel cell 1, two unit cells 11 are supported between a pair of holders 12. Each unit cell 11 includes one MEA 10 and two bipolar plates 20 disposed on both sides of the MEA 10 in a thickness direction of the MEA 10. The bipolar plates 20 may be formed of a conductive metal or carbon. The bipolar plates 20 respectively assembled to the MEA 10 serve as current collectors and include channels for supplying a fuel and oxygen to the catalyst layer of the MEA 10.

Although the fuel cell 1 of FIG. 1 has two unit cells 11, the number of the unit cells is not limited thereto. Dozens to hundreds of unit cells may be used according to the desired characteristics of fuel cells.

Referring to FIG. 2, the MEA 10 includes an electrolyte membrane 100, catalyst layers 110 and 110′ disposed on both sides of the electrolyte membrane 100 in a thickness direction, and gas diffusion layers 120 and 120′, which respectively include micro porous layers 121 and 121′ and support members 122 and 122′ sequentially disposed on the catalyst layers 110 and 110′.

Each of the gas diffusion layers 120 and 120′ may be porous for efficient diffusion of the fuel and oxygen supplied through the bipolar plates 20 of FIG. 1 onto the entire surfaces of the catalyst layers 110 and 110′ and for quick discharge of water generated in the catalyst layers 110 and 110′. In addition, the gas diffusion layer 120 and 120′ may have electrical conductivity for efficient flow of current generated in the catalyst layers 110 and 110′.

The gas diffusion layers 120 and 120′ may include the micro porous layers 121 and 121′ and the support members 122 and 122′, respectively. The support members 122 and 122′ may include an electrically conductive material such as a metal or carbonaceous material. For example, the support members 122 and 122′ may be formed of an electrically conductive material such as carbon paper, carbon cloth, carbon felt, or metal cloth, without being limited thereto.

The micro porous layers 121 and 121′ may generally include small particulate conductive powder such as carbon powder, carbon black, acetylene black, ketjen black, activated carbon, carbon nanotube, carbon nanofiber, carbon nanowire, carbon nanohorn, carbon aerogel, carbon xerogel, carbon nanoring, or fullerene. When the particle diameter of the conductive powder constituting the micro porous layers 121 and 121′ decreases, gas diffusion onto the catalyst layers 110 and 110′ may not be sufficiently performed due to a serious pressure drop. When the particle diameter of the conductive powder increases, the gas diffusion may not be uniformly performed. Thus, conductive particles having an average particle diameter of about 10 nm to about 50 nm may be used in consideration of gas diffusion.

The gas diffusion layers 120 and 120′ may be purchased or prepared by coating the micro porous layers 121 and 121′ on purchased carbon paper. Gas diffusion occurs through pores formed between the conductive particles in the micro porous layers 121 and 121′, and the average diameter of the pores is not particularly limited. For example, the average diameter of the pores of the micro porous layers 121 and 121′ may be in the range of about 1 nm to about 1 mm, about 10 nm to about 800 μm, about 100 nm to about 600 μm, or about 1 μm to about 400 μm. The micro porous layers 121 and 121′ may be omitted in some cases.

The thickness of the gas diffusion layers 120 and 120′ may be in the range of about 100 μm to about 500 μm, about 150 μm to about 450 μm, or about 200 μm to about 400 μm in consideration of gas diffusion and electrical resistance.

The catalyst layers 110 and 110′ serve as a fuel electrode (anode) and an oxygen electrode (cathode) and may include the electrode catalyst layer for fuel cells as described above. The electrode catalyst layer for fuel cells is described above, and thus a detailed description thereof will not be given herein.

The catalyst layers 110 and 110′ may have a thickness of about 1 μm to about 100 μm, about 5 μm to about 80 μm, or about 10 μm to about 60 μm to efficiently activate reaction of the electrodes and to prevent excessive increase of electrical resistance.

The catalyst layers 110 and 110′, the micro porous layers 121 and 121′, and the support members 122 and 122′ may be disposed such that adjacent layers contact each other. If desired, any other layers with different functions may further be interposed therebetween. These layers constitute the anode and the cathode of the MEA 10.

The electrolyte membrane 100 is disposed to closely contact the catalyst layers 110 and 110′. The electrolyte membrane 100 may include at least one polymer electrolyte membrane selected from poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), poly(2,5-benzimidazole, and copolymers thereof.

Protons (hydrogen ions) generated by oxidation of a fuel migrate from an anode to a cathode through electrolyte membrane 100 in a fuel cell. Here, protons (hydrogen ions) migrate in an ionic form bound to water. Since reactions efficiently occur when a sufficient amount of moisture is supplied into the electrolyte membrane and the electrodes of the fuel cell, the fuel cell is generally operated under high relative humidity environment close to 100% relative humidity. However, since gases may not be efficiently circulated in the catalyst layer under such high relative humidity environment, the fuel cell needs to be operated under low relative humidity environment. However, protons (hydrogen ions) may not efficiently migrate under low relative humidity environment.

According to the current embodiment, water retention properties of the catalyst layer may be improved by introducing the inorganic particles with water retention properties into the catalyst layer, thereby facilitating migration of protons (hydrogen ions) under low relative humidity environment. In addition, migration of protons (hydrogen ions) may further be improved via ion exchange by introducing the ionic groups onto the surfaces of the inorganic particles with water retention properties.

For example, the fuel cell may be operated at a driving temperature of about 60° C. to about 250° C. and in a relative humidity of 0% to about 80%.

The fuel cell may be a proton exchange membrane fuel cell (“PEMFC”), a direct methanol fuel cell (“DMFC”), or a phosphoric acid fuel cell (“PAFC”). Since the structure of the fuel cell and the manufacturing method thereof are not particularly limited, and examples are reported in a variety of documents, a detailed description thereof will not be given herein.

Hereinafter, one or more embodiments will be described in detail with reference to the following examples. These examples are not intended to limit the purpose and scope of the one or more embodiments.

### EXAMPLE 1

### (a) Preparation of Silica Particles Having Sulfo Groups

Commercially available silica particles having a particle diameter of about 10 nm were stirred in a 1 M hydrochloric acid solution over 2 hours to form hydrophilic hydroxyl groups on the surfaces of the silica particles, and the silica particles were washed three times with water and dried at 120° C. 1 g of the dried silica particles having the hydroxyl groups on the surfaces thereof were added to a constant-pressure dropping funnel, and stirred for more than 30 minutes while slowly adding 4 g of chlorosulfonic acid thereto. Hydrochloric acid gas generated during the stirring was removed by passing the resultant through water via a tube. After reaction of reforming the hydroxyl groups formed on the surfaces of the silica particles with the sulfo groups is completed, unreacted materials were removed by washing with water, and the reformed silica particles were dried in a vacuum.

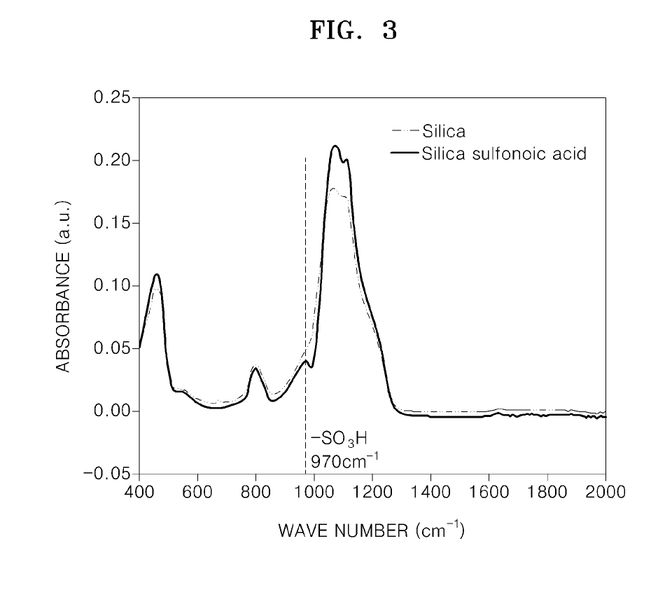

Infrared (“IR”) spectrum was used to identify whether the sulfo groups are formed on the surfaces of the silica particles. FIG. 3 is a graph illustrating IR spectrum results of commercially available silica particles and silica particles having sulfo groups according to Example 1-(a). Referring to FIG. 3, it was confirmed that the sulfo groups were formed on the surfaces of the silica particles prepared according to Example 1-(a) since a peak is observed at 970 reverse centimeters (“cm⁻¹”) in the silica particles of Example 1-(a) differently from the commercially available silica particles.

In addition, ion exchange capacity of the silica particles having the sulfo groups according to Example 1-(a) was measured by back titration using sodium hydroxide. The silica particles having the sulfo groups according to Example 1-(a) had an ion exchange capacity of 0.54 milliequivalents per gram (“meq/g”).

### (b) Preparation of Catalyst Slurry

1 g of polyethylene glycol (PEG, MW=2,000) was dissolved in 19 mL of a dispersion medium including water and isopropyl alcohol (1:1) to prepare a dispersion medium solution.

The silica particles prepared according to Example 1-(a) were mixed with an Aquivion™ solution (Model No.: D79-20BS)(20% by weight of the polymer), as a binder of a fuel cell for high-temperature application, in a content of 2% by weight based on the weight of the polymer, and the mixture was sonicated for more than 1 hour for uniform dispersion. The dispersion medium solution was added to a mixed solution of the silica particles and the binder solution such that the content of PEG is 30% by weight based on the mass of the polymer. The catalyst particles (Pt/C) for fuel cells were mixed therewith, and sufficiently dispersed by sonication. In this regard, the ratio between the mass of the catalyst (Pt/C) and the mass of the polymer binder contained in the binder solution was 7:3.

### (c) Preparation of Catalyst Layer

The catalyst slurry prepared in Example 1-(b) was cast on a polyimide (“PI”) film and dried to prepare a catalyst layer that includes 2% by weight of silica particles and 30% by weight of PEG based on the weight of the binder and has a thickness of about 20 μm.

### (d) Preparation of Unit Cell

The catalyst layer prepared in Example 1-(c) was hot-pressed on both surfaces of an Aquivion™ film (R79-02S), which is an electrolyte membrane for high temperature application, at 120° C. at 1,500 pound per square inch (“psi”) for 3 minutes, and then the PI film was removed. In this regard, the catalyst layer had an area of 5×5 square centimeters (“cm²”). The electrolyte membrane on both side of which the catalyst layers are contacted was interposed between two pieces of carbon paper, serving as gas diffusion layers, and gaskets. The structure was inserted into two carbon plates respectively having gas channels. Then, the structure was assembled using steel use stainless (“SUS”) endplates to prepare unit cells.

### Comparative Example 1

### Silica Particles Having Sulfo Groups (×), PEG(×)>

A catalyst slurry, a catalyst layer, and a unit cell was prepared in the same manner as in Example 1, except that the silica particles having sulfo groups were not used and PEG was not used.

### Comparative Example 2

### Silica Particles Having Sulfo Groups (∘), PEG(×)>

A catalyst slurry, a catalyst layer, and a unit cell was prepared in the same manner as in Example 1, except that PEG was not used.

### Comparative Example 3

### Silica Particles Having Sulfo Groups (×), PEG(∘)>

A catalyst slurry, a catalyst layer, and a unit cell was prepared in the same manner as in Example 1, except that the silica particles having sulfo groups were not used.

### Evaluation Example

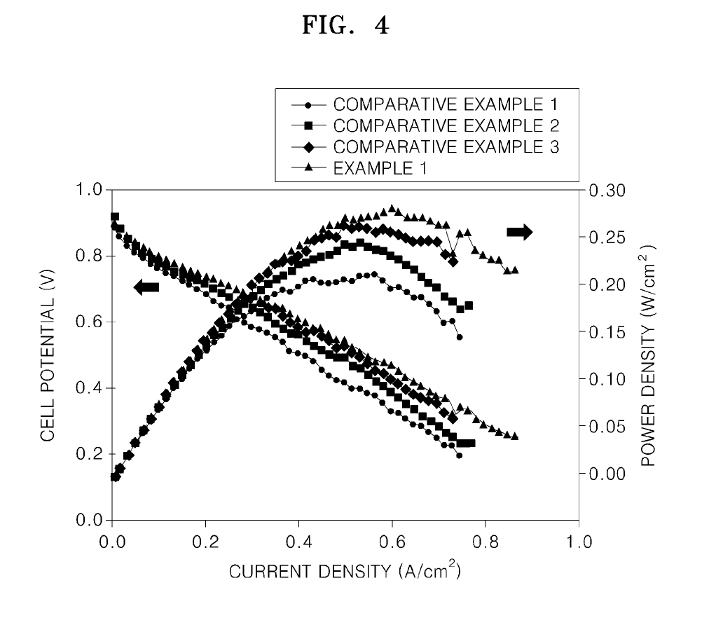

In each of the unit cells prepared according to Example 1, Comparative Example 1, Comparative Example 2, and Comparative Example 3, hydrogen was supplied to the anode and air was supplied to the cathode. Then, power density was measured at 120° C. at 40% relative humidity. The results are shown in FIG. 4 and Tables 1 and 2 below. FIG. 4 is a graph illustrating cell potentials and power densities of unit cells prepared according to Example 1 and Comparative Examples 1 and 2 with respect to current density.

TABLE 1

| | Current | Power | Cell |
|---|---|---|---|
| | density | density | resistance |
| At 0.6 V | (mA/cm²) | (mW/cm²) | (Ω · cm²) |
| Comparative Example 1 | 275 | 165 | 0.764 |
| Comparative Example 2 | 338 | 203 | 1.020 |
| Example 1 | 401 | 241 | 0.233 |

TABLE 2

| | Current density | Power density |
|---|---|---|
| At 0.7 V | (mA/cm²) | (mW/cm²) |
| Comparative Example 1 | 171 | 118 |
| Comparative Example 2 | 205 | 143 |
| Comparative Example 3 | 231 | 162 |
| Example 1 | 247 | 173 |

As illustrated in FIG. 4, power densities of unit cells decrease in the order of Example 1, Comparative Example 3, Comparative Example 2, and Comparative Example 1. It is inferred that the powder density according to Comparative Example 2 is greater than that according to Comparative Example 1 since silica particles contained in the catalyst layer improve water retention properties in the catalyst layer under low relative humidity driving environment, thereby improving proton conductivity. It is inferred that the power density according to Comparative Example 3 is greater than that according to Comparative Example 1 since the presence of PEG in the catalyst layer improves dispersion stability and optimizes the porous structure suitable for maintaining an appropriate catalyst density and providing a gas channel. In addition, it seems that the power density according to Example 1 is greater than that according to Comparative Example 1 in the same reason as in the case that the power densities according to Comparative Examples 2 and 3 are greater than that according to Comparative Example 1. It seems that the power density according to Example 1 is greater than that according to Comparative Example 2 since the presence of PEG improves dispersion stability of the catalyst and optimizes the porous structure. It seems that the power density according to Example 1 is greater than that according to Comparative Example 3 since the silica particles improves water retention properties of the catalyst layer under low relative humidity driving environment, thereby improving proton conductivity, and the ionic groups of the surfaces of the silica particles participate in the proton conducting process, thereby improving proton conductivity in the catalyst layer.

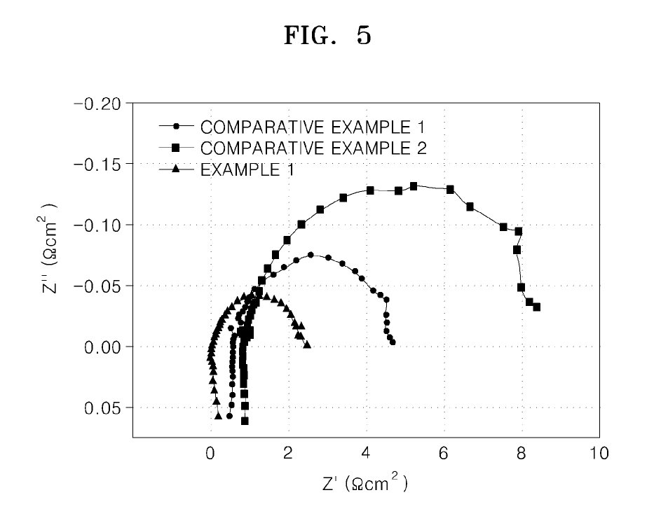

Alternating current (“AC”) impedance of each of the membrane electrode assemblies of unit cells prepared according to Example 1, Comparative Example 1, and Comparative Example 2 was measured at a current density of 0.2 A/cm² (10 kilohertz (“kHz”)-0.1 Hz). FIG. 5 is a graph illustrating alternating current (“AC”) impedance of unit cells prepared according to Example 1 and Comparative Examples 1 and 2. In FIG. 5, Z′ indicates a real part of impedance, and Z″ indicates an imaginary part of the impedance.

In FIG. 5, impedance of the MEA is determined by positions and sizes of semicircles. A first x-intercept of each semicircle indicates resistance of the electrolyte membrane, and a difference between the first x-intercept and a second x-intercept in the semicircle indicates electrode resistance. Referring to FIG. 5, the sizes of the impedance semicircles, the first x-intercepts of the semicircles, and the second x-intercepts of the semicircles increase in the order of Example 1, Comparative Example 1, and Comparative Example 2. Referring thereto, it is confirmed that resistances of the electrolyte membranes and resistances of the electrodes increase in the order of Example 1, Comparative Example 1, and Comparative Example 2. Meanwhile, referring to the impedance graph shown in FIG. 5, the electrodes prepared according to Example 1, Comparative Example 1, and Comparative Example 2 exhibit considerable resistance differences. These differences are caused by different catalyst layers.

As described above, according to the one or more of the above embodiments, a catalyst layer and an electrode having excellent water retention properties, high proton conductivity, and an optimized porous structure may be formed by using the catalyst slurry including the ionic group-containing inorganic particles with water retention properties and the hydrophilic oligomer. Furthermore, a fuel cell having excellent performance may be manufactured by using the electrode including the catalyst layer.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the present disclosure as defined by the following claims.

What is claimed is:

1. A catalyst slurry for a fuel cell comprising:
a catalyst material;
a polymer binder;
a plurality of inorganic particles, wherein each particle comprises an ionic group;
a hydrophilic oligomer; and
a solvent.

2. The catalyst slurry for a fuel cell of claim 1, wherein the inorganic particles have a water retention property.

3. The catalyst slurry for a fuel cell of claim 1, wherein the inorganic particles comprise silica particles, zirconia particles, titania particles, alumina particles, zeolite particles, or a combination thereof.

4. The catalyst slurry for a fuel cell of claim 1, wherein the inorganic particles have a diameter of about 1 nanometer to about 100 nanometers.

5. The catalyst slurry for a fuel cell of claim 1, wherein the ionic group comprises a sulfo group, a carboxyl group, a phosphate group, a phosphono group, an imidazolyl group, a benzimidazolyl group, or a derivative of any one or more of the foregoing groups.

6. The catalyst slurry for a fuel cell of claim 1, wherein the plurality of inorganic particles each comprising an ionic group is a plurality of silica particles, wherein each silica particle comprises a sulfo group.

7. The catalyst slurry for a fuel cell of claim 1, wherein a content of the inorganic particles each comprising an ionic group is in the range of about 1% by weight to about 50% by weight based on the weight of the polymer binder.

8. The catalyst slurry for a fuel cell of claim 1, wherein the hydrophilic oligomer comprises polyethylene glycol, polyvinyl alcohol, polyvinylpyrrolidone, or a combination thereof.

9. The catalyst slurry for a fuel cell of claim 1, wherein a content of the hydrophilic oligomer is in the range of about 1% by weight to about 50% by weight based on the weight of the polymer binder.

10. The catalyst slurry for a fuel cell of claim 1, wherein the catalyst material comprises a support and a catalyst metal disposed on the support.

11. The catalyst slurry for a fuel cell of claim 10, wherein the support comprises carbon powder, carbon black, acetylene black, ketjen black, activated carbon, carbon nanotube, carbon nanofiber, carbon nanowire, carbon nanohorn, carbon aerogel, carbon xerogel, carbon nanoring, or a combination thereof.

12. The catalyst slurry for a fuel cell of claim 10, wherein the catalyst metal comprises platinum, palladium, ruthenium, iridium, osmium, a Pt—Pd alloy, a Pt—Ru alloy, a Pt—Ir alloy, a Pt—Os alloy, a Pt-M alloy, wherein M comprises at least one element selected from titanium, vanadium, chromium, molybdenum, tungsten, manganese, iron, cobalt, rhodium, nickel, copper, silver, gold, zinc, gallium, and tin, or a combination thereof.

13. The catalyst slurry for a fuel cell of claim 1, wherein a content of the catalyst material is in the range of about 10% by weight to about 1,000% by weight based on the weight of the polymer binder.

14. The catalyst slurry for a fuel cell of claim 1, wherein the polymer binder comprises a fluorinate polymer, a benzimidazole polymer, a polyimide polymer, a polyetherimide polymer, a polyphenylenesulfide polymer, a polysulfone polymer, a polyethersulfone polymer, a polyetherketone polymer, a polyether-etherketone polymer, a polyphenylquinoxaline polymer, or a copolymer comprising any one or more of the foregoing polymers.

15. The catalyst slurry for a fuel cell of claim 1, wherein the polymer binder comprises poly(perfluorosulfonic acid), poly(perfluorocarboxylic acid), a copolymer of tetrafluoroethylene and fluorovinylether comprising a sulfonic acid group, defluorinated polyetherketone sulfide, aryl ketone, poly(2,2′-(m-phenylene)-5,5′-bibenzimidazole), poly(2,5-benzimidazole), or a copolymer comprising any one or more of the foregoing polymers.

16. An electrode for a fuel cell comprising:
a gas diffusion layer; and
a catalyst layer disposed on the gas diffusion layer,
wherein the catalyst layer comprises the catalyst slurry according to claim 1.

17. A membrane electrode assembly comprising:
a cathode;
an anode disposed to face the cathode; and
an electrolyte membrane disposed between the cathode and the anode,
wherein at least one of the cathode and the anode comprises the electrode according to claim 16.

18. The membrane electrode assembly claim 17, wherein the electrolyte membrane comprises at least one polymer electrolyte membrane selected from poly(perfluorosulfonic acid), poly(perfluorocarboxylic acid), a copolymer of tetrafluoroethylene and fluorovinylether comprising a sulfonic acid group, defluorinated polyetherketone sulfide, aryl ketone, poly(2,2′-(m-phenylene)-5,5′-bibenzimidazole), poly(2,5-benzimidazole), and a copolymer comprising any one or more of the foregoing polymers.

19. A fuel cell comprising a plurality of the membrane electrode assemblies of claim 17 connected to each other via a plurality of bipolar plates.
